(19) United States
(12) Patent Application Publication
(10) Pub. No.: US 2026/0057841 A1
(43) Pub. Date: Feb. 26, 2026

(54) DISPLAY PANEL AND DISPLAY DEVICE

(71) Applicant: Tianma Advanced Display Technology Institute (Xiamen) Co., Ltd., Xiamen (CN)

(72) Inventors: Zhenyu Jia, Xiamen (CN); Wang Chen, Xiamen (CN); Kerui Xi, Xiamen (CN); Tianyi Wu, Xiamen (CN); Yingteng Zhai, Xiamen (CN); Mingyan Xu, Xiamen (CN); Jiali Huang, Xiamen (CN)

(73) Assignee: Tianma Advanced Display Technology Institute (Xiamen) Co., Ltd., Xiamen (CN)

(21) Appl. No.: 18/922,470

(22) Filed: Oct. 22, 2024

(30) Foreign Application Priority Data
Aug. 26, 2024 (CN) 202411177934.2

(51) Int. Cl. G09G 3/3266; G09G 3/3233

(52) U.S. Cl. CPC G09G 3/3266; G09G 3/3233; G09G 2300/0852; G09G 2300/0866; G09G 2320/0223; G09G 2320/0233

(57) ABSTRACT

The present application discloses a display panel and a display device. The display panel includes a display area; and a first center line, wherein a width of the display panel in a first direction is D, the first center line extends along a second direction, a distance between the first center line and a first edge of the display panel in the first direction is d1, d1=D/4, and at least one gate drive circuit is arranged on each one of two sides of the first center line in the first direction; the first direction and the second direction intersect; the gate drive circuit is located in the display area. According to the embodiments of the present application, a borderless display can be achieved and display uniformity can be improved.

### CROSS-REFERENCE TO RELATED APPLICATIONS

This application claims priority to Chinese Patent Application No. 202411177934.2, titled “DISPLAY PANEL AND DISPLAY DEVICE” and filed on Aug. 26, 2024, which is hereby incorporated by reference in its entirety.

### TECHNICAL FIELD

The present application relates to the field of display technology, and in particular to a display panel and a display device.

### BACKGROUND

With the development of display technology, the application of display panels is becoming more and more common, and users have more and more requirements for display panels. Display panels are gradually developing towards thinness, high screen-to-body ratio, and even borderless display. How to achieve borderless display is an important issue faced by those skilled in the art.

### SUMMARY

The embodiments of the present application provide a display panel and a display device, which can achieve borderless display and improve display uniformity.

In a first aspect, embodiments of the present application provide a display panel, including a display area and a first center line, wherein a width of the display panel in a first direction is D, the first center line extends along a second direction, a distance between the first center line and a first edge of the display panel in the first direction is d1, d1=D/4, and at least one gate drive circuit is arranged on each one of two sides of the first center line in the first direction; the first direction and the second direction intersect; the gate drive circuit is located in the display area.

In a second aspect, embodiments of the present application provide a display device, including a display panel as described in any embodiment of the first aspect.

### BRIEF DESCRIPTION OF THE DRAWINGS

By reading the following detailed description of the non-limiting embodiments with reference to the drawings, other features, purposes and advantages of the present application may become more apparent, wherein the same or similar reference numerals represent the same or similar features, and the drawings are not drawn according to the actual scale.

FIG. 1 shows a schematic structural diagram of a display panel provided in an embodiment of the present application;

FIG. 2 shows another schematic structural diagram of the display panel provided in an embodiment of the present application;

FIG. 3 shows another schematic structural diagram of the display panel provided in an embodiment of the present application;

FIG. 4 shows another schematic structural diagram of the display panel provided in an embodiment of the present application;

FIG. 5 shows a schematic structural diagram of a pixel circuit in the display panel provided in an embodiment of the present application;

FIG. 6 shows another schematic structural diagram of the pixel circuit in the display panel provided in an embodiment of the present application;

FIG. 7 shows another schematic structural diagram of the pixel circuit in the display panel provided in an embodiment of the present application;

FIG. 8 shows another schematic structural diagram of the display panel provided in an embodiment of the present application;

FIG. 9 shows a schematic structural diagram of the area Q1 in FIG. 8;

FIG. 10 shows another schematic structural diagram of the display panel provided in an embodiment of the present application;

FIG. 11 shows another schematic structural diagram of the display panel provided in an embodiment of the present application;

FIG. 12 shows another schematic structural diagram of the display panel provided in an embodiment of the present application;

FIG. 13 shows another schematic structural diagram of the display panel provided in an embodiment of the present application;

FIG. 14 shows another schematic structural diagram of the display panel provided in an embodiment of the present application;

FIG. 15 shows another schematic structural diagram of the display panel provided in an embodiment of the present application;

FIG. 16 shows another schematic structural diagram of the display panel provided in an embodiment of the present application;

FIG. 17 shows another schematic structural diagram of the display panel provided in an embodiment of the present application; and

FIG. 18 shows a schematic structural diagram of a display device provided in an embodiment of the present application.

### REFERENCE NUMERALS

100, display panel;
AA, display area; A1, first sub-display area; A2, second sub-display area;
L1, first center line, L2, second center line;
C1, first edge;
10, gate drive circuit; 10a, first type of gate drive circuit; 10b, second type of gate drive circuit; 10c, third type of gate drive circuit; 10d, other types of gate drive circuit;
11, first gate drive circuit; 12, second gate drive circuit; 13, third gate drive circuit; 14, fourth gate drive circuit; 15, fifth gate drive circuit; 16, sixth gate drive circuit; 17, seventh gate drive circuit;
20, pixel circuit; 201, pixel circuit column;
21, amplitude modulation subcircuit; 22, pulse width modulation subcircuit;
30, light-emitting element;
41, first signal line; 42, second signal line.

### DETAILED DESCRIPTION

The features and exemplary embodiments of various aspects of the present application will be described in detail below. In order to make the purpose, technical solutions and advantages of the present application clearer, the present application will be further described in detail below in conjunction with the drawings and specific embodiments. It should be understood that the specific embodiments described herein are only configured to explain the present application and are not configured to limit the present application. For those skilled in the art, the present application may be implemented without some of these specific details. The following description of the embodiments is only to provide a better understanding of the present application by showing examples of the present application.

It should be noted that in the present application, relational terms such as first and second are only used to distinguish one entity or operation from another entity or operation, and do not necessarily require or imply any such actual relationship or order between these entities or operations. Moreover, the terms “include”, “comprise” or any other variant thereof are intended to cover non-exclusive inclusion, so that a process, method, article or device including a series of elements includes not only those elements, but also other elements not explicitly listed, or also includes elements inherent to such a process, method, article or device. In the absence of further restrictions, the elements defined by the sentence “include . . . ” do not exclude the existence of other identical elements in the process, method, article or device including the elements.

It should be understood that when describing the structure of a component, when a layer or a region is referred to as being “on” or “above” another layer or another region, it may refer to being directly above another layer or another region, or containing other layers or regions between it and another layer or another region. Moreover, if the component is turned over, the layer or region will be “under” or “below” another layer or another region.

It should be understood that the term “and/or” used in the present application is only a description of the association relationship of the associated objects, indicating that there may be three relationships, for example, A and/or B may represent: A exists alone, A and B exist at the same time, and B exists alone. In addition, the character “/” in the present application generally indicates that the associated objects before and after are in an “or” relationship.

In the embodiments of the present application, the term “electrically connected” may refer to the direct electrical connection between two components, or may refer to the electrical connection between two components via one or more other components. The term “drive” may refer to “control” or “operation”. The term “part” may refer to “local”. The term “pattern” may refer to “component”.

It is obvious to those skilled in the art that various modifications and changes can be made in the present application without departing from the spirit or scope of the present application. Therefore, the present application is intended to cover modifications and changes of the present application that fall within the scope of the corresponding claims (technical solutions claimed for protection) and their equivalents. It should be noted that the implementation methods provided in the embodiments of the present application may be combined with each other without contradiction.

Before explaining the technical solutions provided in the embodiments of the present application, in order to facilitate the understanding of the embodiments of the present application, the present application first specifically explains the problems existing in the related art.

The display panel includes a pixel circuit, a light-emitting element and a gate drive circuit. The pixel circuit generates a driving current under the control of the gate drive circuit to drive the light-emitting element to emit light.

The pixel circuits and the light-emitting elements are located in the display area of the display panel. In the related art, the pixel circuits in an edge display area are retracted inwardly to free up the space for the gate drive circuits. This design method can achieve borderless design when the gate drive architecture required by the pixel circuit is not complicated (that is, the number of gate drive circuits is not large). However, as the requirements for driving performance increase, the number of gate drive circuits may increase, so that the design method that only relies on the inward shrinking of the pixel circuits in the edge display area to free up the placement space of the gate drive circuits can no longer meet the architectural design of multiple groups of gate drive circuits. In addition, the gate drive circuits are disposed in the edge display area, and signals output by the gate drive circuits charge from the edge display area to the central display area. For the central display area, the charging distance is far, and there may be signal delay and voltage drop, resulting in poor charging uniformity of the pixel circuit, thereby affecting the display uniformity.

In order to solve the above technical problems, the embodiments of the present application provide a display panel and a display device. The following will describe the various embodiments of the display panel and the display device in conjunction with the drawings.

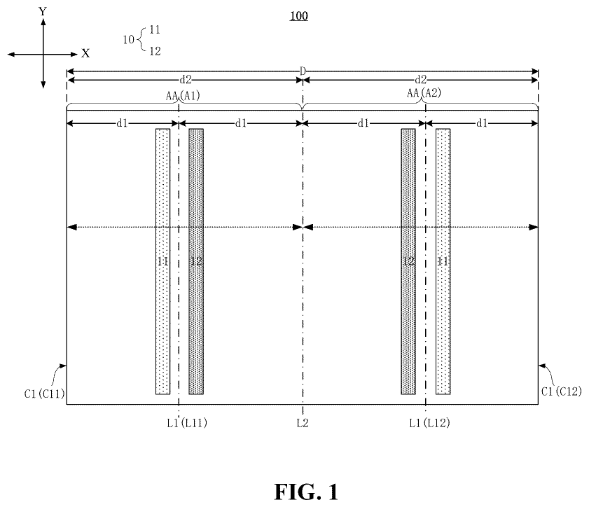

As shown in FIG. 1, the display panel 100 provided in the embodiments of the present application includes a display area AA. It is understandable that the display area AA includes a pixel circuit and a light-emitting element (not shown in FIG. 1), and the display area AA is configured to display an image.

Exemplarily, in the embodiments of the present application, the display panel is a borderless display panel with a narrow border, that is, in a first direction X, the non-display area on the left and right sides of the display area AA is very small, and there may even be no non-display area. Exemplarily, the borderless display panel is used as an example in the drawings of the present application.

The display area AA includes a first sub-display area A1 and a second sub-display area A2 adjacent to each other in the first direction X. FIG. 1 illustrates the first sub-display area A1 as the display area on the left, and the second sub-display area A2 as the display area on the right. The display panel includes a first edge C1 extending along the second direction Y, and two of the first edges C1 are opposite with each other in the first direction X. For the convenience of distinction, C11 in FIG. 1 is a first edge of the first sub-display area A1, and C12 is a first edge of the second sub-display area A2.

A width of the display panel in the first direction X is D, a first center line L1 extends along a second direction Y, and a distance between the first center line L1 and the first edge C1 is d1, d1=D/4. It can be understood that the display panel is divided into left and right half screens in the first direction, and the first center line L1 is a center line of the half screen. For the convenience of distinction, L11 in FIG. 1 is a center line of the first sub-display area A1, and a distance between L11 and C11 is equal to D/4. L12 is a center line of the second sub-display area A2, and a distance between L12 and C12 is equal to D/4.

In the present application, the first direction X intersects with the second direction Y. For example, the first direction X is a row direction, and the second direction Y is a column direction.

It should be noted that the first center line is located in the display area, and the first center line is parallel or approximately parallel to the first edge. The first center line does not represent a real trace of the display panel, and may be understood as a position center line of a virtually defined display panel, that is, the first center line is used to indicate a position. The two or more parameters defined in the embodiments of the present application are “equal”, “equal to”, and “=”, which are not absolutely equal, and a certain error is allowed. It should be noted that the equal distances mentioned in the present disclosure refer to the distance values being equal within the allowable error range (±5%).

A gate drive circuit 10 of the display panel is located in the display area AA, and at least one gate drive circuit 10 is provided on each one of two sides of the first center line L1 in the first direction X.

Exemplarily, at least one gate drive circuit is provided between the first center line L11 of the first sub-display area A1 and the first center line L12 of the second sub-display area A2.

As an example, in the first sub-display area A1, the first gate drive circuit 11 and the second gate drive circuit 12 are provided on both sides of the first center line L11 of the first sub-display area A1 respectively. In the second sub-display area A2, the first gate drive circuit 11 and the second gate drive circuit 12 are also provided on both sides of the first center line L12 of the second sub-display area A2 respectively.

The display panel provided in the embodiments of the present application breaks the conventional design thinking and no longer limits the gate drive circuits to the edge display area, but disperses the gate drive circuits on both sides of the first center line, so that even if the number of gate drive circuits is large, there is enough display area to accommodate the gate drive circuits, thereby achieving the display panel to be a narrow border or even borderless; in addition, compared with limiting the gate drive circuits to the edge display area, the gate drive circuits are dispersed on both sides of the first center line, which can shorten the distances of at least part of the gate drive circuits and the center of the display area, thereby shortening the distances for the gate drive circuits to charge the center of the display area, thereby improving signal delay and voltage drop, and improving display uniformity.

In some embodiments, as shown in FIG. 1, a distance between a second center line L2 of the display panel and the first edge C1 in the first direction X is d2, d2=D/2. At least one gate drive circuit 10 is arranged between the first center line L1 and the second center line L2.

The second center line L2 is a boundary line between the first sub-display area A1 and the second sub-display area A2, and the widths of the first sub-display area A1 and the second sub-display area A2 in the first direction X are equal. It is understandable that a distance between the second center line L2 and the first edge C11 of the first sub-display area A1 is d2, and a distance between the second center line L2 and the first edge C12 of the second sub-display area A2 is also d2. It is equivalent to dividing the display panel into two half-screens in the first direction, and gate drive circuits are arranged on both sides of the first center line of each half-screen.

Exemplarily, the gate drive circuits in each half-screen may be arranged close to the first center line of each half-screen.

For example, in FIG. 1, the two gate drive circuits in the first sub-display area A1 are arranged close to first center line L11 of the first sub-display area A1, and the two gate drive circuits in the second sub-display area A2 are arranged close to first center line L12 of the second sub-display area A2.

In addition, FIG. 1 illustrates that a second gate drive circuit 12 is arranged between the second center line L2 and the first center line L11. It is understandable that a second gate drive circuit 12 is disposed between the second center line L2 and the first center line L11 in the first sub-display area A1, and another second gate drive circuit 12 is disposed between the second center line L2 and the first center line L12 in the second sub-display area A2. The dotted lines with arrows in FIG. 1 each represent a transmission path of the signal output by the second gate drive circuit 12, and it can be seen that a transmission distance of the signal output by the second gate drive circuit 12 is only about one quarter of the width D of the display panel.

It can be understood that for any first gate drive circuit 11 or any second gate drive circuit 12, the transmission distance of its output signal is only about one quarter of the width D of the display panel, which can more effectively shorten the distance for the gate drive circuit to charge, thereby improving signal delay and voltage drop, and improving display uniformity.

The technical concept of the present application may also be explained by a positional relationship between the gate drive circuit and the pixel.

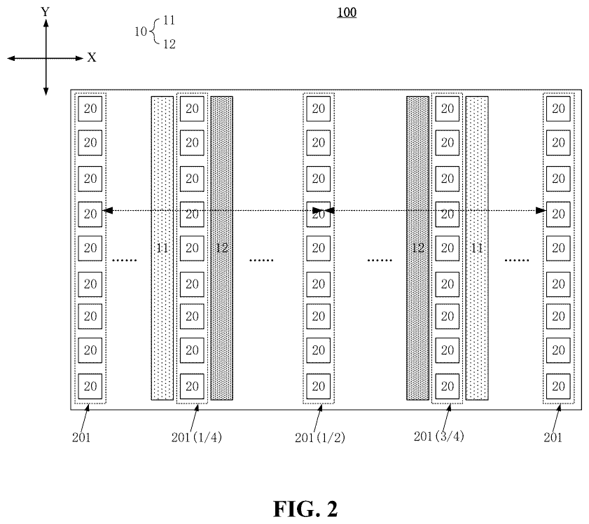

In some embodiments, as shown in FIG. 2, the display panel 100 includes N pixel circuit columns 201 arranged in the first direction X, N is an integer, and the pixel circuit column 201 includes a plurality of pixel circuits 20 arranged in the first direction X. At least one gate drive circuit 10 is provided on each one of two sides of an N/4-th pixel circuit column 201 (¼) in the first direction X, where N/4 is an integer.

In other words, the display panel includes N pixel columns arranged in the first direction, N is an integer, and the pixel column includes a plurality of pixel circuits arranged in the first direction. At least one gate drive circuit is provided on each one of two sides of an N/4-th pixel column in the first direction, where N/4 is an integer.

As shown in FIG. 2, the pixel circuit columns are marked in order from left to right, and the N/4-th pixel circuit column 201 (¼) and the 3N/4-th pixel circuit column 201 (¾) are marked. It can be understood that the 3N/4-th pixel circuit column 201 (¾) from left to right is the N/4-th pixel circuit column 201 from right to left.

The N/4-th pixel circuit column 201 may include the N/4-th pixel circuit column 201 from left to right, and the N/4-th pixel circuit column 201 from right to left.

Exemplarily, at least one gate drive circuit 10 is provided on each one of two sides of the N/4-th pixel circuit column 201 from left to right in the first direction X, and at least one gate drive circuit 10 is provided on each one of two sides of the N/4-th pixel circuit column 201 from right to left in the first direction X.

For example, N=240, from left to right, at least one gate drive circuit is provided on each one of two sides of a 60-th pixel circuit column in the first direction, and, from left to right, at least one gate drive circuit is provided on each one of two sides of a 180-th pixel circuit column in the first direction. In other words, N=240, from right to left, at least one gate drive circuit is provided on each one of two sides of the 60-th pixel circuit column in the first direction, and, from right to left, at least one gate drive circuit is provided on each one of two sides of the 180-th pixel circuit column in the first direction.

In the embodiments of the present application, a positional relationship between the gate drive circuit and the pixel circuit column is improved, and the gate drive circuits are no longer limited to the edge display area, but the gate drive circuits are dispersed on both sides of the N/4-th pixel circuit column. In this way, even if the number of gate drive circuits is large, there is enough display area to accommodate the gate drive circuits, thereby achieving borderless display; in addition, compared with limiting the gate drive circuits to the edge display area, dispersing the gate drive circuits on both sides of the N/4-th pixel circuit column can shorten the distances of at least part of the gate drive circuits and the center of the display area, thereby shortening the distances for the gate drive circuits to charge the center of the display area, and improving signal delay and voltage drop, and improving display uniformity.

In some embodiments, as shown in FIG. 2, along the first direction X, at least one gate drive circuit 10 is included between the N/4-th pixel circuit column 201 (¼) and the N/2-th pixel circuit column 201 (½), where N/2 is an integer.

In other words, along the first direction X, at least one gate drive circuit 10 is included between the N/4-th pixel column and the N/2-th pixel column, where N/2 is an integer.

The N/2-th pixel circuit column may be understood as a pixel circuit column located at the center of the entire display area. The N/4-th pixel circuit column in the left half display area may be understood as a pixel circuit column located at the center of the left half display area, and the N/4-th pixel circuit column in the right half display area may be understood as a pixel circuit column located at the center of the right half display area.

For example, in FIG. 2, two gate drive circuits in the left half display area are arranged on both sides of the pixel circuit column 201 (¼) respectively, and two gate drive circuits in the right half display area are arranged on both sides of the pixel circuit column 201 (¾) respectively. For example, a second gate drive circuit 12 is arranged between the pixel circuit column 201 (¼) and the pixel circuit column 201 (½), and a second gate drive circuit 12 is arranged between the pixel circuit column 201 (¾) and the pixel circuit column 201 (½). The dotted lines with arrows in FIG. 2 represent a transmission path of the signal output by the second gate drive circuit 12. It can be seen that the transmission distance of the signal output by the second gate drive circuit 12 is only about one quarter of the width D of the display panel.

Similarly, for any first gate drive circuit 11 or any second gate drive circuit 12, the transmission distance of its output signal is only about one quarter of the width D of the display panel, which can more effectively shorten the distances for the gate drive circuits to charge, thereby improving signal delay and voltage drop, and improving display uniformity.

It can be understood that the signals output by the gate drive circuits are transmitted to the pixel circuits, and the signals output by the gate drive circuits are used to control the transistors in the pixel circuits to be turned on or off.

The gate drive circuit may include a plurality of cascaded shift registers, and in the same gate drive circuit, a plurality of the shift registers are arranged along the second direction.

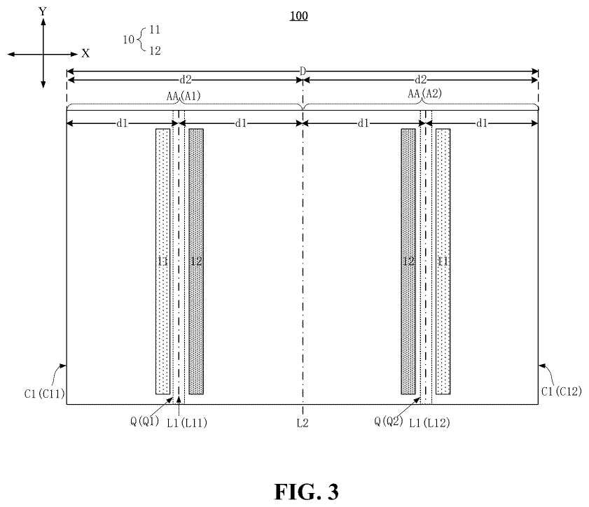

In some embodiments, as shown in FIG. 3, the display panel includes a partition area Q, the first center line L1 is located in the partition area Q, and at least one gate drive circuit 10 is arranged on each one of two sides of the partition area Q in the first direction X, and a width of the partition area Q in the first direction X is less than or equal to 625 μm.

Exemplarily, a partition area in the first sub-display area A1 is a first partition area Q1, a center line L11 is located in the first partition area Q1, and at least one gate drive circuit 10 is arranged on each one of the left and right sides of the first partition area Q1. A partition area in the second sub-display area A2 is a second partition area Q2, a center line L12 is located in the second partition area Q2, and at least one gate drive circuit 10 is provided on each one of the left and right sides of the second partition area Q2.

In the embodiments of the present application, the partition area separates the gate drive circuits on the left and right sides thereof, that is, the gate drive circuits may not be arranged adjacently, which can reduce the signal interference between different gate drive circuits.

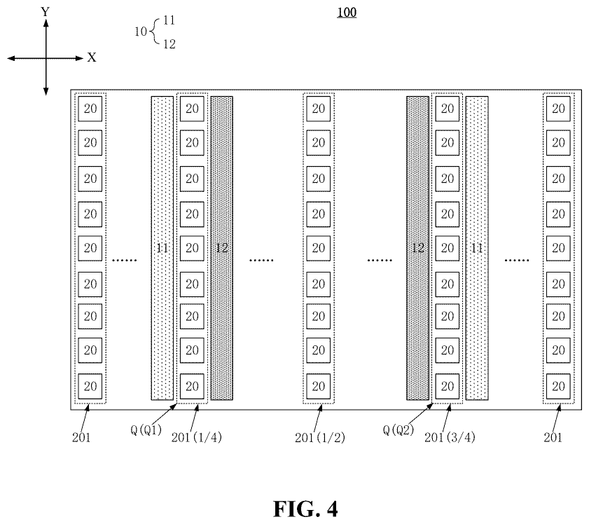

In some embodiments, as shown in FIG. 4, the display panel includes N pixel circuit columns 201 arranged in the first direction X, and the pixel circuit column 201 includes a plurality of pixel circuits 20 arranged in the second direction Y; the N/4-th pixel circuit column 201 (¼) is located in the partition area Q1.

The 3N/4-th pixel circuit column 201 (¾) from left to right in FIG. 4 is the N/4-th pixel circuit column from right to left. The partition area Q in FIG. 4 may also include a first partition area Q1 and a second partition area Q2, and the pixel circuit column 201 (¼) is located in the first partition area Q1, and the pixel circuit column 201 (¾) is located in the second partition area Q2.

In the embodiments of the present application, the partition area separates the gate drive circuits on the left and right sides thereof, and the pixel circuits are arranged in the partition area to avoid wasting space.

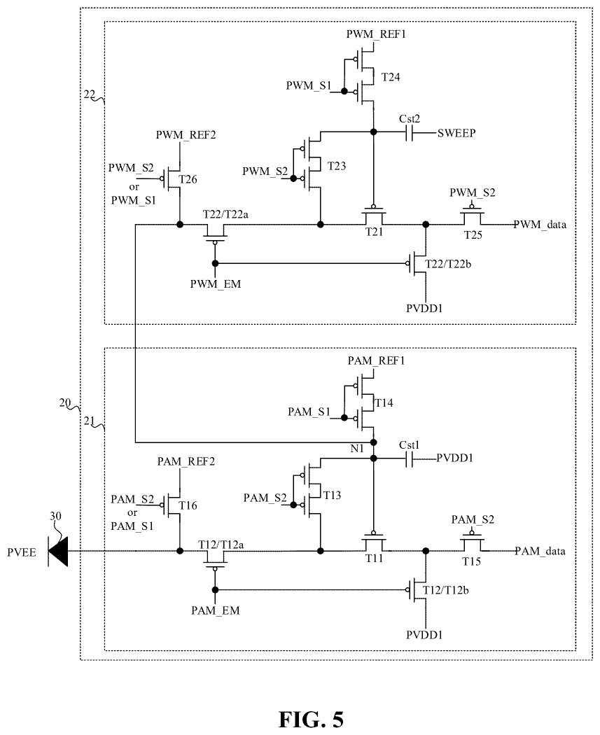

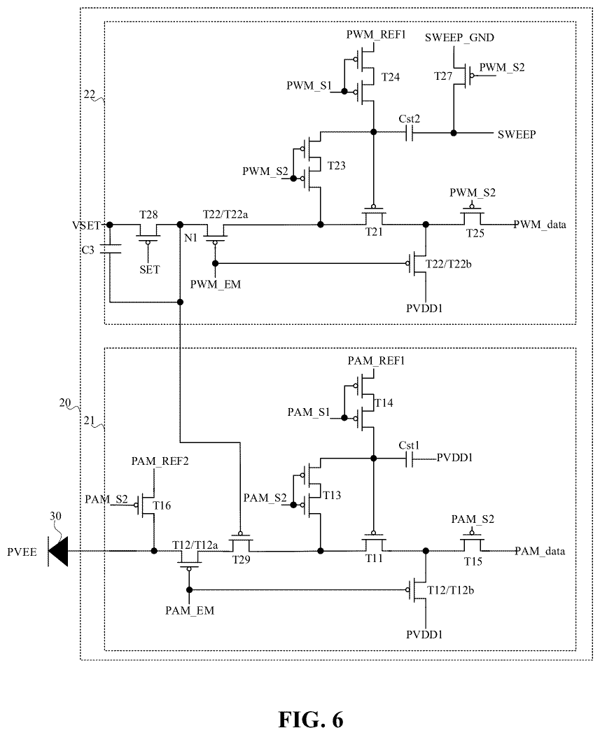

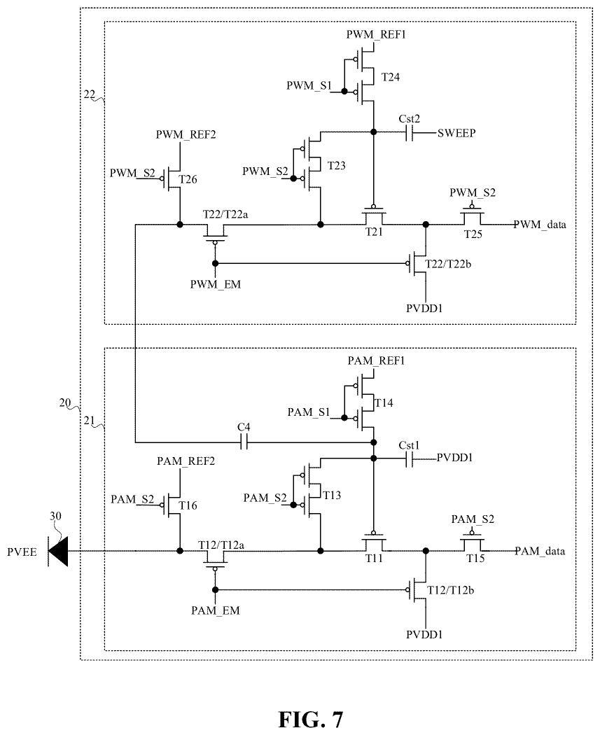

In some embodiments, as shown in any one of FIG. 5 to FIG. 7, the pixel circuit 20 of the display panel includes an amplitude modulation subcircuit 21 and a pulse width modulation subcircuit 22, and the gate drive circuit includes a first gate drive circuit 11 and a second gate drive circuit 12, and the gate signal output by the first gate drive circuit 11 is used to control the first data signal PAM_data to be written into the amplitude modulation subcircuit 21, and the gate signal output by the second gate drive circuit 12 is used to control the second data signal PWM_data to be written into the pulse width modulation subcircuit 22.

In order to meet the driving requirements of high-resolution display panels, such as micro LED (Micro Light Emitting Diode) or organic LED (Organic Light Emitting Diode) display panels, a pixel circuit combining pulse amplitude modulation (PAM) and pulse width modulation (PWM) is used to control the intensity of the driving current and the duration of the driving current to control the light-emitting state of the light-emitting element.

The amplitude modulation subcircuit 21 and the pulse width modulation subcircuit 22 are connected. The pixel circuit 20 generates a driving current under the control of the amplitude modulation subcircuit 21 and the pulse width modulation subcircuit 22. The amplitude modulation subcircuit 21 can be used to control the amplitude of the driving current, and the pulse width modulation subcircuit 22 can be used to adjust the pulse width of the voltage applied to the first electrode of the light-emitting element 30.

The pulse width modulation subcircuit 22 adjusts the pulse width of the voltage applied to the first electrode of the light-emitting element 30, that is, the pulse width modulation subcircuit 22 adjusts the actual emission period of the driving current applied to the light-emitting element 30, and at the same time, the driving current applied to the light-emitting element is maintained at a constant level to adjust the grayscale or brightness displayed by the light-emitting element, rather than only adjusting the magnitude of the driving current applied to the light-emitting element to adjust the grayscale or brightness displayed by the light-emitting element. Therefore, the amplitude modulation subcircuit 21 can provide a driving current to the light-emitting element so that the light-emitting element is driven with the best luminous efficiency, and adjust the grayscale or brightness displayed by the light-emitting element by adjusting the light-emitting duty cycle of the light-emitting element (that is, the emission period of the light-emitting element) through the pulse width modulation subcircuit 22.

In the drawings of the present application, PAM_S2 represents the gate signal output by the first gate drive circuit 11, PWM_S2 represents the gate signal output by the second gate drive circuit 12, PAM_data represents a first data signal, and PWM_data represents a second data signal.

It should be noted that the circuit structures shown in FIG. 5 to FIG. 7 are only exemplary and are not used to limit the present application. Regardless of the specific structures of the amplitude modulation subcircuit and the pulse width modulation subcircuit in the pixel circuit, both of them usually need to be written with data signals, so the design concept of the gate drive circuit in the present application may also be applied to pixel circuits of other structural forms other than the circuit structures shown in FIG. 5 to FIG. 7.

In some embodiments, as shown in FIG. 8, in the first direction X, the first gate drive circuit 11 is located on one side of the first center line L1 close to the second center line L2, and the second gate drive circuit 12 is located on one side of the first center line L1 facing away from the second center line L2.

Alternatively, as shown in FIG. 1, in the first direction X, the first gate drive circuit 11 is located on one side of the first center line L1 facing away from the second center line L2, and the second gate drive circuit 12 is located on one side of the first center line L1 close to the second center line L2.

Exemplarily, as shown in FIG. 1 or FIG. 8, the first gate drive circuit 11 and the second gate drive circuit 12 are arranged on each one of two sides of the second center line L2, and two of the first gate drive circuits 11 on both sides of the second center line L2 are symmetrical with respect to the second center line L2, and two of the second gate drive circuits 12 on both sides of the second center line L2 are symmetrical with respect to the second center line L2, so that the signal distribution output by the first gate drive circuit and the second gate drive circuit may be relatively uniform, thereby improving the display uniformity.

As shown in FIG. 8, in the first direction X, a distance between the first gate drive circuit 11 and the first center line L1 is marked as d3, and a distance between the second gate drive circuit 12 and the first center line L1 is marked as d4. It should be noted that d3 and d4 in FIG. 8 are only used to illustrate distances of the gate drive circuits and the first center line, and are not used to limit the sizes of d3 and d4.

In some embodiments, d3=d4.

For example, the signals output by the first gate drive circuit and the second gate drive circuit are the same. In a case of d3=d4, the first gate drive circuit and the second gate drive circuit can be distributed relatively evenly. For the entire display area, the signal delay and voltage drop output by the first gate drive circuit and the second gate drive circuit may be relatively uniform, thereby improving display uniformity.

In other embodiments, d3≠d4.

The driving requirements of the amplitude modulation subcircuit and the pulse width modulation subcircuit may be different, so that the signals output by the first gate drive circuit and the second gate drive circuit may be different. When d3d4, the relative distribution positions of the first gate drive circuit and the second gate drive circuit may be flexibly adjusted to flexibly match the different driving requirements of the amplitude modulation subcircuit and the pulse width modulation subcircuit.

As an example, d3<d4.

The closer the gate drive circuit is to the first center line, the closer the flow path of the output signal of the gate drive circuit is to one quarter of the width of the display panel, and the lower the signal delay and voltage drop of the output signal of the gate drive circuit may be. The amplitude modulation subcircuit has a relatively large impact on the luminous brightness, and the gate signal output by the first gate drive circuit is used to control the writing of the data signal of the amplitude modulation subcircuit, so the signal of the first gate drive circuit has a relatively large impact on the luminous brightness. In the case of d3<d4, the first gate drive circuit is arranged closer to the first center line, so that the signal delay and voltage drop of the first gate drive circuit may be relatively low, thereby improving the display uniformity.

It is understandable that in other examples, if the signal delay and voltage drop of the second gate drive circuit are required to be relatively low, the second gate drive circuit can be arranged to be closer to the first center line.

Both the first gate drive circuit and the second gate drive circuit include an input terminal and an output terminal. The input terminal of the gate drive circuit can be used to access at least one of the following clock signals (CK, CKB), a trigger signal (STV), a fixed voltage signal (VGH and/or VGL), and a reset signal (Reset). The output terminal of the gate drive circuit is used to output a gate signal, the gate signal is used to control the pixel circuit. The output terminal of the gate drive circuit is electrically connected to the pixel circuit. For example, an output terminal of the gate drive circuit is electrically connected to a plurality of pixel circuits located in the same row.

It is understandable that, when the first gate drive circuit is disposed on each one of two sides of the second center line, the closer the output terminal of the first gate drive circuit is to the first center line, the closer the transmission path of the signal output by the first gate drive circuit is to one quarter of the width of the display panel, and the same is true for the second gate drive circuit.

In some embodiments, in the first direction, an input terminal of the first gate drive circuit is closer to the first center line than an output terminal of the first gate drive circuit, and an input terminal of the second gate drive circuit is closer to the first center line than an output terminal of the second gate drive circuit. In this way, the transmission path of the signal output by the output terminal of the first gate drive circuit is closer to one quarter of the width of the display panel, and the transmission path of the signal output by the output terminal of the first gate drive circuit is closer to one quarter of the width of the display panel.

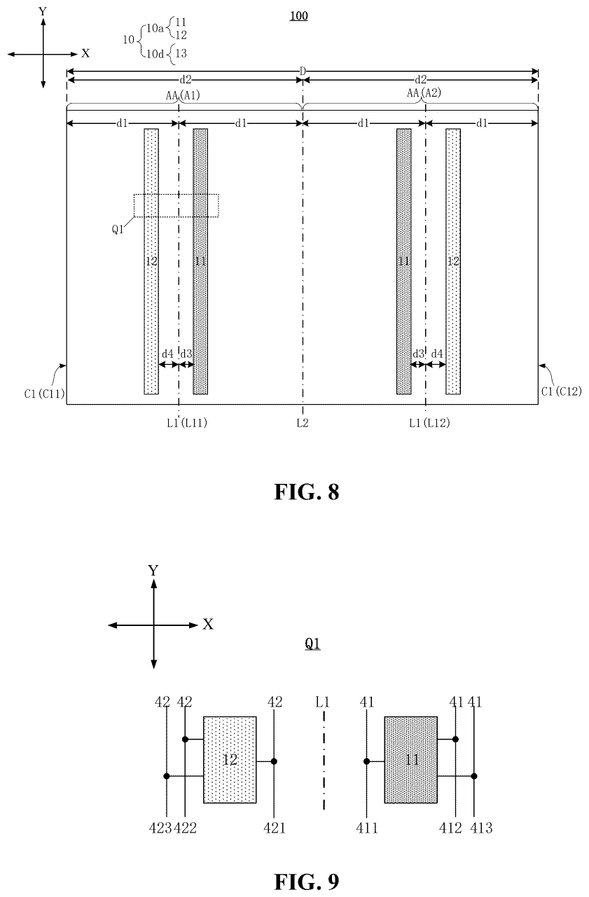

In some embodiments, as shown in FIG. 9, the first gate drive circuit 11 is connected to a plurality of first signal lines 41. In the first direction X, the number of first signal lines 41 distributed on one side of the first gate drive circuit 11 close to the first center line L1 is n1, and the number of first signal lines 41 distributed on one side of the first gate drive circuit 11 facing away from the first center line L1 is n2, and n1<n2.

The second gate drive circuit 12 is connected to a plurality of second signal lines 42. In the first direction X, the number of second signal lines 42 distributed on one side of the second gate drive circuit 12 close to the first center line L1 is n3, and the number of second signal lines 42 distributed on one side of the second gate drive circuit 12 facing away from the first center line L1 is n4, and n3<n4.

Both the first signal line 41 and the second signal line 42 extend along the second direction Y. At least part of the signals of the plurality of signal lines connected to the gate drive circuits are connected to the driver chip, and the signals output by the driver chips are transmitted to the gate drive circuits via the signals to realize the control of the gate drive circuits.

In FIG. 9, a signal line distributed on one side of the first gate drive circuit 11 close to the first center line L1 is marked as a signal line 411, and signal lines distributed on one side of the first gate drive circuit 11 facing away from the first center line L1 are marked as signal lines 412 and 413 respectively. Exemplarily, the signal line 411 can be used for fixing voltage signals or other signals, and the signal lines 412 and 413 can be used for transmitting two clock signals or other signals with misaligned timing.

In FIG. 9, a signal line distributed on one side of the second gate drive circuit 12 close to the first center line L1 is marked as a signal line 421, and signal lines distributed on one side of the second gate drive circuit 12 facing away from the first center line L1 are marked as signal lines 422 and 423 respectively. Exemplarily, signal line 421 can be used for fixing voltage signals or other signals, and signal lines 422 and 423 can be used for transmitting two clock signals or other signals with misaligned timing.

It should be noted that the number of signal lines shown in FIG. 9 is only exemplary and is not used to limit the present application.

In the embodiments of the present application, the number of first signal lines distributed on one side of the first gate drive circuit close to the first center line is relatively small, so that a smaller space can be designed between the first gate drive circuit and the first center line, that is, the first gate drive circuit can be arranged closer to the first center line, thereby reducing the delay and voltage drop of signal output by the first gate drive circuit. Similarly, the number of second signal lines distributed on one side of the second gate drive circuit close to the first center line is relatively small, so that a smaller space can be designed between the second gate drive circuit and the first center line, that is, the second gate drive circuit can be arranged closer to the first center line, thereby reducing the delay and voltage drop of signal output by the second gate drive circuit.

The pixel circuit may include a data writing module, a gate reset module, an anode reset module, etc. The data writing module is used to write data signals, and the writing degree of the data signal directly affects the brightness, that is, compared with other functional modules, the data writing module has a greater impact on the brightness, so the signal of the gate drive circuit that controls the data writing module has a greater impact on the brightness.

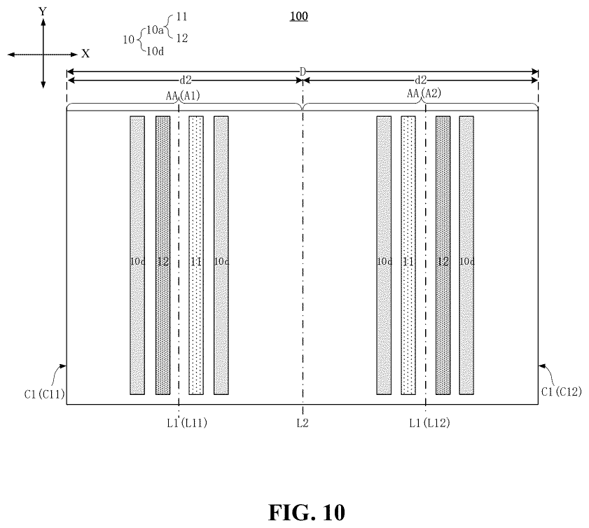

In view of this, in some embodiments, as shown in FIG. 10, the gate drive circuit 10 includes a first type of gate drive circuit 10a and other types of gate drive circuits 10d, and the gate signal output by the first type of gate drive circuit 10a is used to control the data signal to be written into the pixel circuit. In the first direction X, a distance between the first type of gate drive circuit 10a and the first center line L1 is less than distances of the other types of gate drive circuits 10d and the first center line L1. In this way, the first type of gate drive circuit is closer to the first center line, so that the delay and voltage drop of signal output by the first type of gate drive circuit are relatively low, so as to improve display uniformity.

For example, for the first type of gate drive circuit 10a and the other type of gate drive circuit 10d located on the same side of the first center line L1, the first type of gate drive circuit 10a is located between the first center line L1 and the other type of gate drive circuit 10d.

Exemplarily, the first type of gate drive circuit 10a includes the first gate drive circuit 11 and the second gate drive circuit 12 mentioned above. At least one other type of gate drive circuit 10d may be distributed on one side of the first gate drive circuit 11 facing away from the first center line L1, and at least one other type of gate drive circuit 10d may also be distributed on one side of the second gate drive circuit 12 facing away from the first center line L1. At least two other types of gate drive circuits 10d on the same side of the second center line L2 are used to control different functional modules in the pixel circuit. For example, one other type of gate drive circuit 10d is used to control the reset signal to be written into the pixel circuit, one other type of gate drive circuit 10d is used to control the light-emitting control signal to be written into the pixel circuit, and one other type of gate drive circuit 10d is used to provide a frequency sweeping signal (SWEEP), etc.

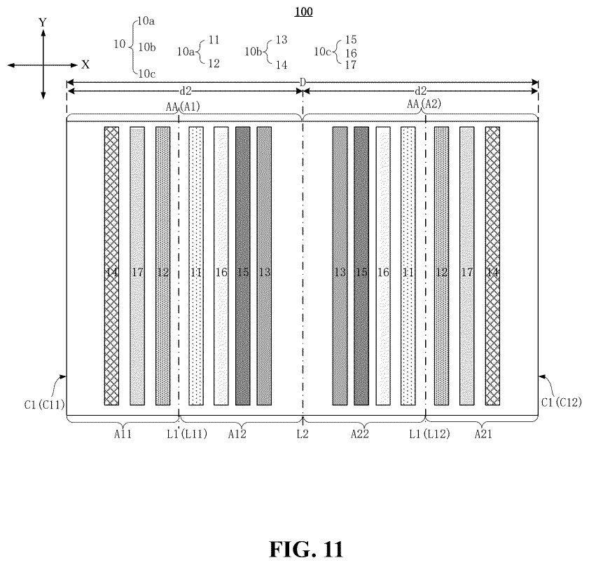

In some embodiments, as shown in FIG. 11, the gate drive circuit 10 includes a first type of gate drive circuit 10a, a second type of gate drive circuit 10b and a third type of gate drive circuit 10c. The gate signal output by the first type of gate drive circuit 10a is used to control the data signal to be written into the pixel circuit, the gate signal output by the second type of gate drive circuit 10b is used to control the reset signal to be written into the pixel circuit, and the third type of gate drive circuit 10c is used to output a frequency sweeping signal and/or a light-emitting control signal. The third type of gate drive circuit 10c is disposed between the first type of gate drive circuit 10a and the second type of gate drive circuit 10b in the first direction X.

Exemplarily, referring to FIG. 11 and any one of FIG. 5 to FIG. 7, the gate signal output by the first type of gate drive circuit 10a includes PAM_S2 and PWM_S2, the gate signal output by the second type of gate drive circuit 10b includes PAM_S1 and PWM_S1, and the gate signal output by the third type of gate drive circuit 10c includes PAM_EM, PWM_EM, and SWEEP. PAM_REF1, PAM_REF2, PWM_REF1, PWM_REF2 represent reset signals.

Exemplarily, referring to FIG. 11, in the first direction X, the display area AA is divided into four sub-areas, which are a first sub-area A11, a second sub-area A12, a third sub-area A22, and a fourth sub-area A21 respectively. The first sub-area A11 and the second sub-area A12 are separated by the center line L11, the third sub-area A22 and the fourth sub-area A21 are separated by the center line L12, and the second sub-area A12 and the third sub-area A22 are separated by the second center line L2. For each sub-area, the first type of gate drive circuit 10a, the second type of gate drive circuit 10b and the third type of gate drive circuit 10c may be arranged therein, and a distribution pattern in each sub-area is that: the third type of gate drive circuit 10c is located between the first type of gate drive circuit 10a and the second type of gate drive circuit 10b.

As described above, the closer the gate drive circuit is to the first center line, the smaller the flow distance of its output signal can be. The writing of the data signal directly affects the size of the driving current, and its influence on the brightness is the greatest. The light-emitting control signal and the frequency sweeping signal affect the light-emitting duration of the light-emitting element, and their influence on the brightness is second, and the reset signal has the least influence on the brightness. In the embodiments of the present application, the first type of gate drive circuit with the greatest influence on the brightness is disposed closest to the first center line, the second type of gate drive circuit with the least influence on the brightness is disposed farthest from the first center line, and the third type of gate drive circuit is disposed between the two. In this way, the importance of the influence of various types of gate drive circuits on the brightness can be matched, which is more conducive to optimizing the display uniformity.

In some embodiments, referring to FIG. 11 and FIG. 5, the pixel circuit 20 includes an amplitude modulation subcircuit 21 and a pulse width modulation subcircuit 22, and the second type of gate drive circuit 10b includes a third gate drive circuit 13 and a fourth gate drive circuit 14. The gate signal output by the third gate drive circuit 13 is PAM_S1, and the gate signal output by the fourth gate drive circuit 14 is PWM_S1. The gate signal output by the third gate drive circuit 13 is used to control the reset signal PAM_REF1 to be written into the amplitude modulation subcircuit 21, and the gate signal output by the fourth gate drive circuit 14 is used to control the reset signal PWM_REF1 to be written into the pulse width modulation subcircuit 22; in the first direction X, the third gate drive circuit 13 and the fourth gate drive circuit 14 are located on both sides of the first center line L1 respectively.

Exemplarily, as shown in FIG. 11, for the display areas on the same side of the second center line L2, the third gate drive circuit 13 is located on one side of the first center line L1 close to the second center line L2, and the fourth gate drive circuit 14 is located on one side of the first center line L1 facing away from the second center line L2. In other examples, the third gate drive circuit 13 may also be located on one side of the first center line L1 facing away from the second center line L2, and the fourth gate drive circuit 14 may also be located on one side of the first center line L1 close to the second center line L2.

Exemplarily, as shown in FIG. 5, the writing of the reset signal PAM_REF2 can be controlled by the gate signal PAM_S2 or PAM_S1, and the writing of the reset signal PWM_REF2 can be controlled by the gate signal PWM_S2 or PWM_S1. As described above, the gate signal PAM_S2 is provided by the first gate drive circuit, and the gate signal PWM_S2 is provided by the second gate drive circuit.

In the embodiments of the present application, for the display areas on the same side of the second center line L2, the third gate drive circuit 13 and the fourth gate drive circuit 14, which have the least influence on the brightness, are located on both sides of the first center line L1 respectively, so that there is a certain space on both sides of the first center line L1 to place other gate drive circuits that have a relatively large influence on the brightness, in this way, the overall layout can be optimized.

In some embodiments, referring to FIG. 11 and FIG. 5, the pixel circuit 20 includes an amplitude modulation subcircuit 21 and a pulse width modulation subcircuit 22, and the third type of gate drive circuit 10c includes a fifth gate drive circuit 15, a sixth gate drive circuit 16 and a seventh gate drive circuit 17, the fifth gate drive circuit 15 is used to output the first light-emitting control signal PAM_EM, the sixth gate drive circuit 16 is used to output the second light-emitting control signal PWM_EM, and the seventh gate drive circuit 17 is used to output the frequency sweeping signal SWEEP, the fifth gate drive circuit 15 is electrically connected to the amplitude modulation subcircuit 21, and the sixth gate drive circuit 16 and the seventh gate drive circuit 17 are electrically connected to the pulse width modulation subcircuit 22; in the first direction X, the fifth gate drive circuit 15 and the sixth gate drive circuit 16 are adjacent.

The gate signals output by the fifth gate drive circuit 15 and the sixth gate drive circuit 16 are both used to control the light-emitting time. The adjacent arrangement of the two can make the signal delay and voltage drop of the two tend to be consistent, thereby avoiding a large difference in the control of the light-emitting time between the two.

Exemplarily, a group of fifth gate drive circuit 15 and sixth gate drive circuit 16 is arranged on each one of two sides of the second center line L2, and the fifth gate drive circuit 15 and the sixth gate drive circuit 16 are adjacent to each other on any side of the second center line L2.

In some embodiments, referring to FIG. 11, in the first direction X, the fifth gate drive circuit 15 and the sixth gate drive circuit 16 are located on one side of the first center line L1, and the seventh gate drive circuit 17 is located on the other side of the first center line L1.

Exemplarily, the fifth gate drive circuit 15 and the sixth gate drive circuit 16 are located on one side of the first center line L1 close to the second center line L2, and the seventh gate drive circuit 17 is located on one side of the first center line L1 facing away from the second center line L2. Of course, in other examples, it can also be that the fifth gate drive circuit 15 and the sixth gate drive circuit 16 are located on one side of the first center line L1 facing away from the second center line L2, and the seventh gate drive circuit 17 is located on one side of the first center line L1 close to the second center line L2.

The fifth gate drive circuit 15, the sixth gate drive circuit 16 and the seventh gate drive circuit 17 have the same influence on brightness. If the three are located on the same side of the first center line, there must be one that is farther away from the first center line, and the farther away from the first center line is, the greater the signal delay and voltage drop are. In the embodiments of the present application, the three are distributed on both sides of the first center line, so that the distances of the three and the first center line tend to be consistent, and the signal delay and voltage drop of the three also tend to be consistent, so as to optimize the display uniformity.

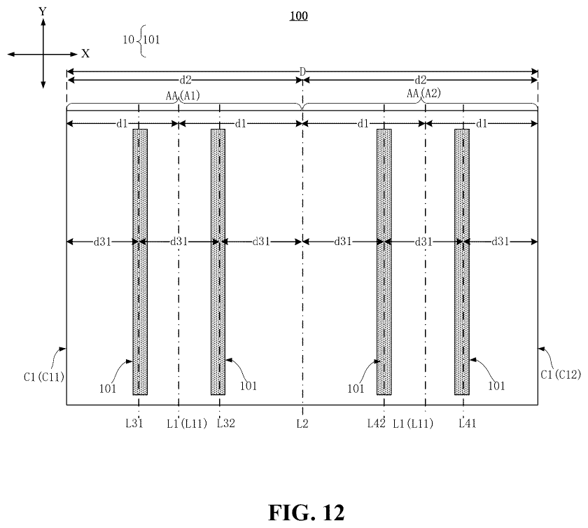

In some embodiments, as shown in FIG. 12, the display panel 100 includes two sub-display areas arranged in the first direction X, and the sub-display area includes a first center line L1. The two sub-display areas are the first sub-display area A1 and the second sub-display area A2 respectively, the first center line of the first sub-display area A1 is L11, and the first center line of the second sub-display area A2 is L12.

The gate drive circuit includes a target gate drive circuit 101, and the same sub-display area includes n target gate drive circuits 101 that output the same gate signal. The n target gate drive circuits 101 in the sub-display area are evenly distributed in the first direction X, and n≥2.

FIG. 12 illustrates that each sub-display area includes two target gate drive circuits 101. For the first sub-display area A1, it includes a one-third line L31 and a two-thirds line L32. A distance between the one-third line L31 and the two-thirds line L32 is d31, a distance between the one-third line L31 and the edge C11 is d31, and a distance between the two-thirds line L32 and the second center line L2 is d31, the d31 is one-third of width D of the display panel. One of the target gate drive circuits 101 may be disposed on the one-third line L31, and the other target gate drive circuit 101 may be disposed on the two-thirds line L32.

Similarly, for the second sub-display area A2, it includes a one-third line L41 and a two-thirds line L42, a distance between the one-third line L41 and the two-thirds line L42 is d31, a distance between the one-third line L41 and the edge C12 is d31, and a distance between the two-thirds line L42 and the second center line L2 is d31, the d31 is one-third of width D of the display panel. One of the target gate drive circuits 101 may be disposed on the one-third line L41, and the other target gate drive circuit 101 may be disposed on the two-thirds line L42.

The more gate drive circuits that output the same gate signal, the stronger the driving capability, and the n target gate drive circuits 101 are evenly distributed, which can minimize the delay and voltage drop of the output signal of the target gate drive circuit 101.

The more gate drive circuits that output the same gate signal, the stronger the driving capability, and the more space occupied. Exemplarily, in the case of taking into account both the driving capability and the layout design, n may not be greater than 4.

In some embodiments, n target gate drive circuits 101 are all used to output the frequency sweeping signal SWEEP; or, n target gate drive circuits 101 are all used to output the first light-emitting control signal PAM_EM for controlling the amplitude modulation subcircuit in the pixel circuit.

That is, the target gate drive circuit 101 may be the seventh gate drive circuit 17 mentioned above, or the target gate drive circuit 101 may be the fifth gate drive circuit 15 mentioned above.

Compared with other gate drive circuits, the seventh gate drive circuit 17 and the fifth gate drive circuit 15 have relatively large parasitic capacitance, which may affect their driving capability. Therefore, multiple seventh gate drive circuits 17 or multiple fifth gate drive circuits 15 are provided in the sub-display area to balance the driving capability of each gate drive circuit.

In some embodiments, the n target gate drive circuits 101 include n first gate drive circuits 11, and the gate signals PAM_S2 output by the n first gate drive circuits 11 are used to control the first data signal PAM_data to be written into the amplitude modulation subcircuit 21; and/or, the n target gate drive circuits 101 include n second gate drive circuits 12, and the gate signals PWM_S2 output by the n second gate drive circuits 12 are used to control the second data signal PWM_data to be written into the pulse width modulation subcircuit.

As described above, the writing of data signals has a greater impact on brightness, so multiple first gate drive circuits and/or multiple second gate drive circuits are disposed in the sub-display area, which can enhance the driving capability of the first gate drive circuit and/or the second gate drive circuit, and can achieve more effective control over the writing of data signals.

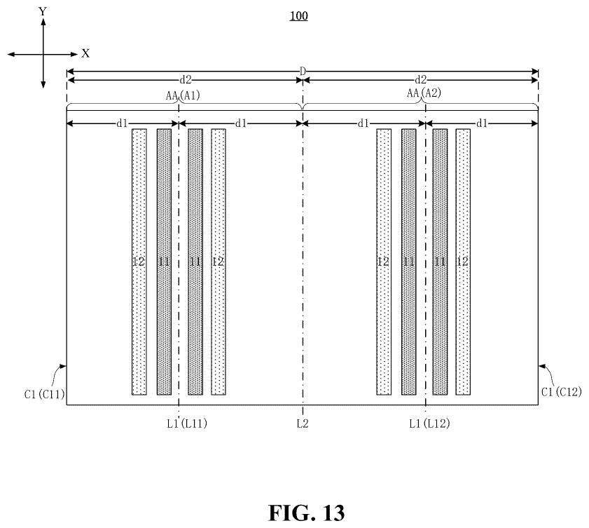

As an example, as shown in FIG. 13, each sub-display area includes two first gate drive circuits 11 and two second gate drive circuits 12, and are arranged in the order of the second gate drive circuit 12, the first gate drive circuit 11, the first center line L1, the first gate drive circuit 11, and the second gate drive circuit 12.

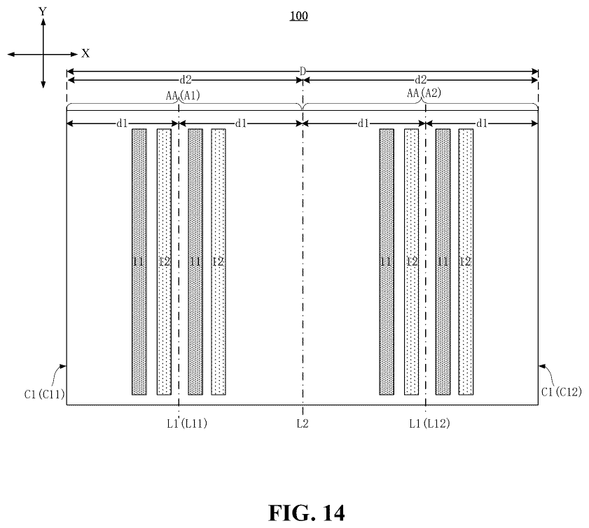

As another example, as shown in FIG. 14, each sub-display area includes two first gate drive circuits 11 and two second gate drive circuits 12, and are arranged in the order of the first gate drive circuit 11, the second gate drive circuit 12, the first center line L1, the first gate drive circuit 11, and the second gate drive circuit 12.

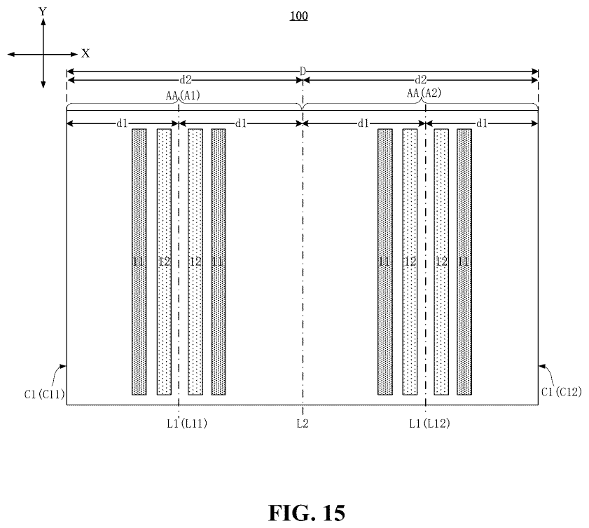

As another example, as shown in FIG. 15, each sub-display area includes two first gate drive circuits 11 and two second gate drive circuits 12, and are arranged in the order of the first gate drive circuit 11, the second gate drive circuit 12, the first center line L1, the second gate drive circuit 12, and the first gate drive circuit 11.

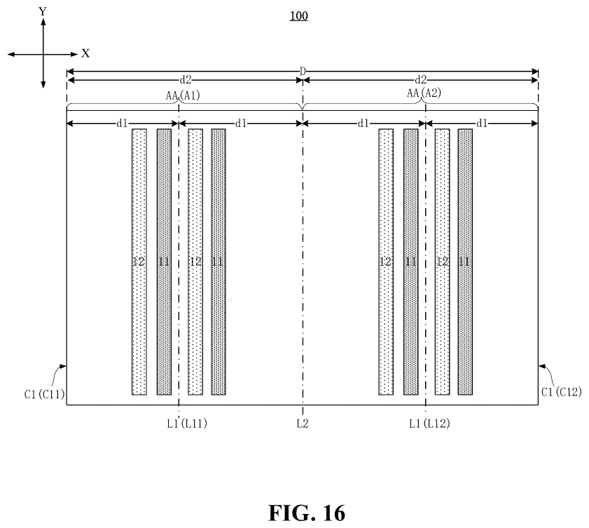

As another example, as shown in FIG. 16, each sub-display area includes two first gate drive circuits 11 and two second gate drive circuits 12, and is arranged in the order of the second gate drive circuit 12, the first gate drive circuit 11, the first center line L1, the second gate drive circuit 12, and the first gate drive circuit 11.

The above are only some examples and are not used to limit the present application. The arrangement order of multiple first gate drive circuits and multiple second gate drive circuits may also be set in other ways, which are not listed here.

In some embodiments, as shown in FIG. 11, the display panel 100 includes two sub-display areas arranged in the first direction X, and each sub-display area includes a first center line L1. The two sub-display areas are the first sub-display area A1 and the second sub-display area A2 respectively, the first center line of the first sub-display area A1 is L11, and the first center line of the second sub-display area A2 is L12.

Along the first direction X, two of the sub-display areas each include m gate drive circuits 10, the m gate drive circuits 10 are gate drive circuits from the K1-th gate drive circuit to the Km-th gate drive circuit respectively, gate signals output by the Kj-th gate drive circuit in the first sub-display area and the Kj-th gate drive circuit in the second sub-display area are the same, m≥2, Kj is any one of K1 to Km;

In the first direction X, the K1-th gate drive circuit to the Km-th gate drive circuit in the first sub-display area are arranged close to the second center line L2 in sequence, and the K1-th gate drive circuit to the Km-th gate drive circuit in the second sub-display area are arranged away from the second center line L2 in sequence, and the second center line L2 is the boundary line between the two sub-display areas.

In FIG. 11, m is 7, indicating that the fourth gate drive circuit 14 is the K1-th gate drive circuit, and the third gate drive circuit 13 is the Km-th gate drive circuit.

It is understandable that in the embodiments of the present application, the arrangement order of the gate drive circuits in the two sub-display areas is symmetrical, so that transmission paths of signals output by the gate drive circuits in the two sub-display areas are also symmetrical, which is more conducive to optimizing display uniformity.

Of course, the gate drive circuits may also be arranged in other orders.

As an example, in the same sub-display area, in the first direction, the third gate drive circuit 13 (output signal PAM_S1), the seventh gate drive circuit 17 (output signal SWEEP), the second gate drive circuit 12 (output signal PWM_S2), the first center line L1, the first gate drive circuit 11 (output signal PAM_S2), the sixth gate drive circuit 16 (output signal PWM_EM), the fifth gate drive circuit 15 (output signal PAM_EM), and the fourth gate drive circuit 14 (output signal PWM_S1) are arranged in this order.

As another example, in the same sub-display area, in the first direction, the fourth gate drive circuit 14 (output signal PWM_S1), the second gate drive circuit 12 (output signal PWM_S2), the first center line L1, the first gate drive circuit 11 (output signal PAM_S2), the seventh gate drive circuit 17 (output signal SWEEP), the sixth gate drive circuit 16 (output signal PWM_EM), the fifth gate drive circuit 15 (output signal PAM_EM), and the third gate drive circuit 13 (output signal PAM_S1) are arranged in this order.

As another example, in the same sub-display area, in the first direction, the fourth gate drive circuit 14 (output signal PWM_S1), the sixth gate drive circuit 16 (output signal PWM_EM), the fifth gate drive circuit 15 (output signal PAM_EM), the second gate drive circuit 12 (output signal PWM_S2), the first center line L1, the first gate drive circuit 11 (output signal PAM_S2), the seventh gate drive circuit 17 (output signal SWEEP), and the third gate drive circuit 13 (output signal PAM_S1) are arranged in the order.

The above only shows part of the arrangement modes, and the arrangement orders of respective gate drive circuits are not listed here one by one.

In some embodiments, as shown in FIG. 11, the display panel 100 includes two sub-display areas arranged in the first direction X, and each sub-display area includes a first center line L1. The two sub-display areas are the first sub-display area A1 and the second sub-display area A2 respectively, the first center line of the first sub-display area A1 is L11, and the first center line of the second sub-display area A2 is L12.

The sub-display area includes a plurality of gate drive circuits 10. In the first direction X, the plurality of gate drive circuits 10 in the same sub-display area are arranged at unequal intervals.

The circuit architectures of the gate drive circuits for providing different gate signals are different, so the layout area occupied by the gate drive circuits with different functions or the number of signal lines required to be connected are different. In a case that the gate drive circuits are arranged at unequal intervals, it is easier to arrange each gate drive circuit in a reasonable design mode.

As an example, any adjacent of the two gate drive circuits 10 are a circuit group, and a spacing distance between the two gate drive circuits 10 in at least one circuit group in the first direction X is d11, and a spacing distance between the two gate drive circuits 10 in at least another circuit group in the first direction X is d12, and d11≠d12.

Specifically, spacing distances between respective gate drive circuits may be set according to actual needs, which are not limited in the present application.

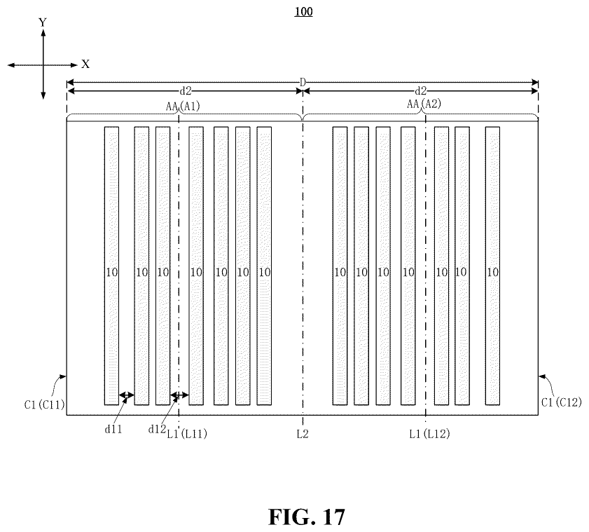

As another example, any adjacent of the two gate drive circuits are a circuit group, the number of pixel circuit columns (not shown in FIG. 17) distributed between the two gate drive circuits in at least one circuit group is m1, and the number of pixel circuit columns distributed between the two gate drive circuits in at least another circuit group is m2, m1≠m2.

In a case that multiple gate drive circuits 10 in the same sub-display area are arranged at unequal intervals, spaces between the respective gate drive circuits are different. For a larger spacing distance, the space between the gate drive circuits is larger, and more pixel circuit columns may be disposed in the space, so that each space is reasonably utilized. For a smaller spacing distance, the space between the gate drive circuits is smaller, and a small number of pixel circuit columns may be disposed in this space. If more pixel circuit columns are disposed in a small space, the pixel circuit columns may be too crowded, which is more likely to cause the signal to be crosstalked or interfered; or the pixel circuit size has to be reduced, resulting in reduced performance of the pixel circuit, and the embodiments of the present application can avoid the above-mentioned situation.

In some embodiments, as shown in FIG. 2 or FIG. 4, the display area includes a pixel circuit 20, and an orthographic projection of the pixel circuit 20 on a plane where the display panel is located does not overlap an orthographic projection of the gate drive circuit 10 on the plane where the display panel is located.

In the embodiments of the present application, the pixel circuits are no longer arranged adjacently in a column, but spaces are freed up between the columns of pixel circuits, so that there are spaces in the display area to place the gate drive circuits, and the gate drive circuits can be disposed in the display area to achieve borderless display.

In some embodiments, the sizes of the pixel circuits 20 in different areas are the same. For example, sizes of the pixel circuits in the entire display area are reduced as a whole. After the sizes of the pixel circuits are reduced, there is a certain space between the columns of pixel circuits, and the gate drive circuits are disposed in a gap between the columns of pixel circuits.

If the sizes of the pixel circuits in only some areas are reduced, the driving capabilities of the pixel circuits in different areas may be different, resulting in poor display uniformity. In the embodiments of the present application, the sizes of the pixel circuits in the entire display area are reduced as a whole, and the sizes of respective pixel circuits after reduction are still the same, so the driving capabilities of the pixel circuits in the respective areas are still consistent, which may not affect the display uniformity.

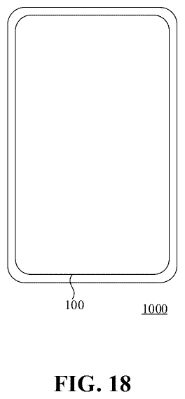

The present application also provides a display device, including a display panel provided by the present application. Referring to FIG. 18, FIG. 18 is a schematic structural diagram of a display device provided by an embodiment of the present application. The display device 1000 provided by FIG. 18 includes a display panel 100 provided by any of the above embodiments of the present application. The embodiment of FIG. 18 only takes a mobile phone as an example to illustrate the display device 1000. It can be understood that the display device provided by the embodiments of the present application may be a wearable product, a computer, a television, a car display device, and other display devices with display functions, which is not specially limited in the present application. The display device provided by the embodiments of the present application has the beneficial effects of the display panel provided by the embodiments of the present application. For details, referring to the specific description of the display panel in the above embodiments, which is not repeated in this embodiment here.

According to the embodiments of the present application as described above, these embodiments do not describe all the details in detail, nor do they limit the present application to only the specific embodiments described. Apparently, according to the above description, many modifications and changes can be made. The specification selects and describes these embodiments in detail in order to better explain the principles and practical applications of the present application, so that those skilled in the technical field can make good use of the present application and modify and use it based on the present application. The present application is limited only by the claims appended hereto along with their full scope and equivalents.

What is claimed is:

1. A display panel, comprising a display area; and
a first center line, wherein a width of the display panel in a first direction is D, the first center line extends along a second direction, a distance between the first center line and a first edge of the display panel in the first direction is d1, d1=D/4, and at least one gate drive circuit is arranged on each side of the first center line in the first direction; the first direction and the second direction intersect;
the gate drive circuit is located in the display area.

2. The display panel according to claim 1, wherein a distance between a second center line of the display panel and the first edge of the display panel in the first direction is d2, d2=D/2, and at least one gate drive circuit is arranged between the first center line and the second center line; or,
wherein the display panel comprises N pixel circuit columns that are arranged in the first direction, and at least one of the pixel circuit columns comprises a plurality of pixel circuits arranged in the second direction;
at least one gate drive circuit is arranged on each side of the N/4-th pixel circuit column in the first direction, where N/4 is an integer.

3. The display panel according to claim 2, wherein along the first direction, at least one gate drive circuit is included between the N/4-th pixel circuit column and the N/2-th pixel circuit column, where N/2 is an integer.

4. The display panel according to claim 1, wherein the display panel comprises a partition area, the first center line is located in the partition area, at least one gate drive circuit is arranged on each side of the partition area in the first direction, and a width of the partition area in the first direction is less than or equal to 625 μm.

5. The display panel according to claim 4, wherein the display panel comprises N pixel circuit columns arranged in the first direction, and at least one of the pixel circuit columns comprises a plurality of pixel circuits arranged in the second direction;
the N/4-th pixel circuit column is located in the partition area.

6. The display panel according to claim 2, wherein a pixel circuit of the display panel comprises an amplitude modulation subcircuit and a pulse width modulation subcircuit, the gate drive circuit comprises a first gate drive circuit and a second gate drive circuit, a gate signal output by the first gate drive circuit is to control a first data signal to be written into the amplitude modulation subcircuit, and a gate signal output by the second gate drive circuit is to control a second data signal to be written into the pulse width modulation subcircuit.

7. The display panel according to claim 6, wherein
in the first direction, the first gate drive circuit is located on a side of the first center line close to the second center line, and the second gate drive circuit is located on a side of the first center line facing away from the second center line;
or, in the first direction, the first gate drive circuit is located on the side of the first center line facing away from the second center line, and the second gate drive circuit is located on the side of the first center line close to the second center line.

8. The display panel according to claim 7, wherein
in the first direction, a distance between the first gate drive circuit and the first center line is d3, a distance between the second gate drive circuit and the first center line is d4, and d3=d4; or,
wherein in the first direction, a distance between the first gate drive circuit and the first center line is d3, and a distance between the second gate drive circuit and the first center line is d4, and d3≠d4.

9. The display panel according to claim 7, wherein in the first direction, an input terminal of the first gate drive circuit is closer to the first center line than an output terminal of the first gate drive circuit, and an input terminal of the second gate drive circuit is closer to the first center line than an output terminal of the second gate drive circuit; or,
wherein the first gate drive circuit is connected to a plurality of first signal lines, and in the first direction, a number of the first signal lines distributed on a side of the first gate drive circuit close to the first center line is n1, and a number of the first signal lines distributed on a side of the first gate drive circuit facing away from the first center line is n2, and n1<n2;
the second gate drive circuit is connected to a plurality of second signal lines, and in the first direction, a number of the second signal lines distributed on a side of the second gate drive circuit close to the first center line is n3, and a number of the second signal lines distributed on a side of the second gate drive circuit facing away from the first center line is n4, and n3<n4.

10. The display panel according to claim 1, wherein the gate drive circuit comprises a first type of gate drive circuit and other types of gate drive circuits, and a gate signal output by the first type of gate drive circuit is to control a data signal to be written into a pixel circuit;
in the first direction, a distance between the first type of gate drive circuit and the first center line is less than distances of the other types of gate drive circuits and the first center line.

11. The display panel according to claim 1, wherein the gate drive circuit comprises a first type of gate drive circuit, a second type of gate drive circuit and a third type of gate drive circuit, a gate signal output by the first type of gate drive circuit is to control a data signal to be written into a pixel circuit, a gate signal output by the second type of gate drive circuit is to control a reset signal to be written into the pixel circuit, and a third type of gate drive circuit is configured to output a frequency sweeping signal and/or a light-emitting control signal;
in the first direction, the third type of gate drive circuit is disposed between the first type of gate drive circuit and the second type of gate drive circuit.

12. The display panel according to claim 11, wherein the pixel circuit comprises an amplitude modulation subcircuit and a pulse width modulation subcircuit, the second type of gate drive circuit comprises a third gate drive circuit and a fourth gate drive circuit, a gate signal output by the third gate drive circuit is to control the reset signal to be written into the amplitude modulation subcircuit, and a gate signal output by the fourth gate drive circuit is to control the reset signal to be written into the pulse width modulation subcircuit;
in the first direction, the third gate drive circuit and the fourth gate drive circuit are located on both sides of the first center line respectively.

13. The display panel according to claim 12, wherein the pixel circuit comprises the amplitude modulation subcircuit and the pulse width modulation subcircuit, the third type of gate drive circuit comprises a fifth gate drive circuit, a sixth gate drive circuit and a seventh gate drive circuit, the fifth gate drive circuit is configured to output a first light-emitting control signal, the sixth gate drive circuit is configured to output a second light-emitting control signal, the seventh gate drive circuit is configured to output a frequency sweeping signal, the fifth gate drive circuit is electrically connected to the amplitude modulation subcircuit, the sixth gate drive circuit and the seventh gate drive circuit are electrically connected to the pulse width modulation subcircuit;
in the first direction, the fifth gate drive circuit and the sixth gate drive circuit are adjacent.

14. The display panel according to claim 13, wherein in the first direction, the fifth gate drive circuit and the sixth gate drive circuit are located on one side of the first center line, and the seventh gate drive circuit is located on the other side of the first center line.

15. The display panel according to claim 1, wherein the display panel comprises two sub-display areas arranged in the first direction, at least one of the sub-display areas comprises the first center line;
one of the sub-display areas comprise n target gate drive circuits that output the same gate signal, and the n target gate drive circuits in the sub-display area are evenly distributed in the first direction, n≥2.

16. The display panel according to claim 15, wherein the n target gate drive circuits are all configured to output a frequency sweeping signal;
or, the n target gate drive circuits are all configured to output a first light-emitting control signal for controlling an amplitude modulation subcircuit in a pixel circuit; or, wherein the n target gate drive circuits comprise n first gate drive circuits, and gate signals output by the n first gate drive circuits are to control a first data signal to be written into an amplitude modulation subcircuit;
and/or, the n target gate drive circuits comprise n second gate drive circuits, and gate signals output by the n second gate drive circuits are to control a second data signal to be written into a pulse width modulation subcircuit.

17. The display panel according to claim 1, wherein the display panel comprises two sub-display areas arranged in the first direction, and at least one of the sub-display areas comprises the first center line;
along the first direction, two of the sub-display areas comprise m gate drive circuits, and the m gate drive circuits are gate drive circuits from the K1-th gate drive circuit to the Km-th gate drive circuit respectively, and gate signals output by the Kj-th gate drive circuit in the first sub-display area and the Kj-th gate drive circuit in the second sub-display area are the same, m≥2, and Kj is any one of K1 to Km;
in the first direction, the K1-th gate drive circuit to the Km-th gate drive circuit in the first sub-display area are arranged close to a second center line in sequence, and the K1-th gate drive circuit to the Km-th gate drive circuit in the second sub-display area are arranged away from the second center line in sequence, and the second center line is a boundary line between two of the sub-display areas.

18. The display panel according to claim 1, wherein the display panel comprises two sub-display areas arranged in the first direction, and at least one of the sub-display areas comprises the first center line;
at least one of the sub-display areas comprises a plurality of the gate drive circuits, and in the first direction, the plurality of the gate drive circuits in one of the sub-display areas are arranged at unequal intervals.

19. The display panel according to claim 18, wherein any adjacent of the two gate drive circuits are a circuit group, a spacing distance between the two gate drive circuits in the at least one circuit group in the first direction is d11, and a spacing distance between the two gate drive circuits in the at least another circuit group in the first direction is d12, d11≠d12; or,
wherein any adjacent of the two gate drive circuits are a circuit group, a number of pixel circuit columns distributed between the two gate drive circuits in the at least one circuit group is m1, and a number of pixel circuit columns distributed between the two gate drive circuits in the at least another circuit group is m2, m1≠m2.

20. A display device, comprising a display panel comprising a display area; and
a first center line, wherein a width of the display panel in a first direction is D, the first center line extends along a second direction, a distance between the first center line and a first edge of the display panel in the first direction is d1, d1=D/4, and at least one gate drive circuit is arranged on each side of the first center line in the first direction; the first direction and the second direction intersect;
the gate drive circuit is located in the display area.
